(19) United States
(12) Patent Application Publication
(10) Pub. No.: US 2003/0231661 A1
(43) Pub. Date: Dec. 18, 2003

(54) Optimized broadband download for large content

(75) Inventors: Mark DePietro, Harleysville, PA (US); Reem Safadi, Horsham, PA (US); Louis Mastrocola, Blue Bell, PA (US); Peter Sheedy, Huntingdon Valley, PA (US)

Correspondence Address: MAYER, FORTKORT & WILLIAMS, PC, 251 NORTH AVENUE WEST, 2ND FLOOR, WESTFIELD, NJ, 07090, US

(73) Assignee: General Instrument Corporation

(21) Appl. No.: 10/174,296

(22) Filed: Jun. 18, 2002

(51) Int. Cl. H04J 3/24

(52) U.S. Cl. 370/474; 370/476

(57) ABSTRACT

A method and apparatus for rapidly downloading large files over a broadband communications link to a user segments the file into multiple segments and assigns the segments to be transmitted over a plurality of in-band or out-of-band channels. The segments are then carouseled on the assigned channels. Optionally, the segmenting algorithm may optimize the download time based on: file size, unused bandwidth per multiplex, the number of available multiplexes, or channels most viewed during the download period. The optimization program can begin the download process employing all available channels. Subsequently, based on acknowledgements regarding maximum successfully received segments, the optimization program can then reallocate the unsent segments among these channels. When the receiver is tuned to a given channel that has associated with it one or more segments to be downloaded, the receiver starts downloading these segments as a background process, which continues until the download of the entire filed is complete, whether or not the channel is changed by a viewer.

### FIELD OF THE INVENTION

The present invention relates generally to methods and apparatus for transmitting data over a communications network, and more particularly to a method and apparatus for transmitting data over a broadband communications network that provides multiple data services, including broadcast and interactive services.

### BACKGROUND

Many techniques exist for downloading large data files over a communications network. Nevertheless, there is a continuing need to reduce the transaction time needed to download these large files, particularly as the deployed devices require these large files for functional purposes (e.g., upgrades). Moreover, as client devices that are connected to a cable broadband network (e.g., set-top boxes and cable modems) utilize local storage of various types, such as hard drives, the capacity to download and store these extremely large files increases. For example, broadcast programming can now be stored for later viewing in certain devices that employ large capacity storage. Thus, there is a growing need to reduce the strain on network resources by ensuring that these large data files are transmitted in an increasingly efficient manner and without disrupting other services.

The present invention is therefore directed to the problem of developing a method and apparatus for downloading large data files over a broadband multi-data service communications network that operates in an optimum manner.

### SUMMARY OF THE INVENTION

The present invention solves these and other problems by providing a method and apparatus for downloading large data files that utilizes multiple multiplexes (e.g., in-band channels or out-of-band channels) during the download process.

One exemplary embodiment of this process includes segmenting the large data file and trickling the segments down a pre-selected number of in-band channels as part of a background process. In this case, the download may be initiated in the cable headend or the uplink.

Various segmentation methods may be employed. One exemplary embodiment of a segmentation method is based on an intelligent segmentation in-band channel allocation scheme that takes into account a distribution function of the most-likely viewed channels corresponding to the time of download by users who are most likely to request the download. For example, if subscribers owning consumer devices, such as Motorola Digital Cable Terminals (DCT's), with Personal Versatile Recoders (PVR's) typically tune to specific channels, such as HBO, USA and Cinemax, during prime time and the file download is scheduled to occur at that time, then the segmentation scheme maximizes the utility of the spare bandwidth on these channels to increase the hit/miss ratio. In other words, these channels are selected as the download in-band channels to which various file segments are allocated, thereby increasing the probability that the download process will begin, as this requires the viewer to tune to the channel to which the file segment is assigned before a download process can initiate for that file segment, even if the viewer merely surfs through the channel. Once the download process is initiated, the process will continue until complete despite a channel change by the viewer.

Alternatively, a unified distribution scheme may be utilized at first (e.g., in which file segments are spread out evenly across a given number of selected in-band channels) and later optimized based on a received pattern returned by a resident program operating in conjunction with the download function in the Digital Cable Terminal. This mechanism periodically tracks the segment capture (or reception) patterns in the Digital Cable Terminal and sends this information upon request to the headend-downloading device. The downloading device in the headend analyzes this data to adjust its segment-in-band channel download allocation to optimize the hit/miss ratio while avoiding instability.

Other aspects of the present invention will be apparent from a reading of the following in concert with the figures.

### BRIEF DESCRIPTION OF THE DRAWINGS

FIG. 1 depicts an exemplary embodiment of an apparatus according to one aspect of the present invention.

FIG. 2 depicts an exemplary embodiment of a method for downloading a large file over a multiple data service communications network according to another aspect of the present invention.

FIG. 3 depicts an exemplary embodiment of another method for downloading a large file over a multiple data service communications network according to yet another aspect of the present invention.

### DETAILED DESCRIPTION

It is worthy to note that any reference herein to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

The present invention provides inter alia a method and apparatus for rapidly downloading large files over a broadband communications link to a user. The methods and apparatuses disclosed herein may be employed in any communication network that provides broadband data communication and broadcast services, such as a cable network that provides both broadcast video services and two-way internet access. However, the present invention is not limited to cable networks. In particular, the present invention is applicable to any communication network that includes multiple services to each user, of which services only a few can be utilized in any instant by a user of the network.

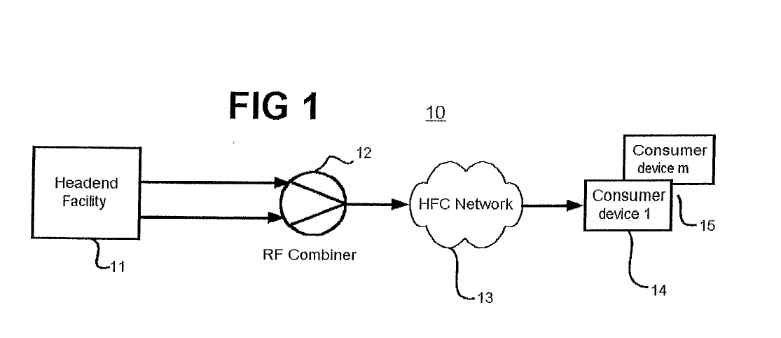

Turning to FIG. 1, shown therein is a communications network architecture to which various aspects of the present invention may be applicable. This network provides multiple data services to many different users over a broad range of communication media. A cable head-end 11 may be a regionalized or a distributed cable headend connected directly to a Hybrid Fiber Coax distribution network. The download schemes apply equally regardless of the distribution network architecture.

Assume a user desires to download a large data file over a broadband connection that is providing other data services, such as video or other high bandwidth service. In our example, the connection to the user includes both video service and two-way data service. One method of the present invention splits the large data file into multiple segments, and then intelligently selects various channels containing video services over which to transmit the multiple segments. According to one aspect of the present invention, the method selects the video channels based on the viewing patterns of the user, which are periodically uploaded to the source from which the large data file is to be downloaded. In the case of multiple users of the same video service, the viewing patterns of multiple users are aggregated and the download or downloads for all users are segmented and transmitted based on the viewing patterns in the aggregate.

One device for use at the user end of the communication process comprises a Motorola Digital Cable Terminal (DCT), e.g., Model 2000, which is a hybrid digital/analog terminal for transmitting, inter alia, MPEG-2 video & Dolby® Digital Audio. Other Motorola DCTs include a built-in DOCSIS cable modem, a Triple-Tuner™ architecture for simultaneous viewing television or video, talking using a form of internet instant messaging or IP telephone, or surfing the world wide web. The Motorola DCT provides high-level broadband networking services without sacrificing traditional analog and digital video services. Through a MIPS processor, 32 bit true color/3D graphics, integrated DOCSIS compliant cable modem, and optional hard drive, this device enables cable system operators to offer additional revenue generating services that require dedicated upstream bandwidth. To ensure system security of the interactive services, the Motorola DCT employs Motorola's access control and encryption technology. The consumer electronics interfaces include S-Video, SPDIF (AC-3), Ethernet, USB, and IEEE1394 (Firewire), Y, P_{b}, Pᵣ, (components of decompressed signal) interfacing to an HDTV.

One exemplary embodiment of this process includes segmenting the large data file and trickling the segments down a pre-selected number of in-band channels. In this case, the download may be initiated in the cable headend or the uplink.

Various segmentation methods may be employed. One exemplary embodiment of a segmentation method is based on an intelligent segment-in-band channel allocation scheme that takes into account a distribution function of the viewed channels corresponding to the time of download by users who are most likely to request the download. For example, if subscribers owning consumer devices, such as Motorola Digital Cable Terminals (DCT's) with personal video recorders (PVR's) typically tune to CNN, HBO, USA and Cinemax during prime time and the download is to take place at that time, then the segmentation scheme would maximize the utility of the spare bandwidth on these channels to increase the hit/miss ratio while avoiding instability by calculating the average time spent on each channel by each user for any given duration.

Alternatively, a unified distribution scheme may be utilized at first, e.g., segments are spread out evenly across a given number of in-band channels, and later optimized based on the pattern reflected by a resident program operating in conjunction with the download function in the consumer device. This mechanism periodically tracks the segment capture (or reception) patterns in the consumer device and sends this information upon request to the headend downloading device. The downloading device in the headend analyzes this data to adjust its segment-in-band channel download allocation to optimize the hit/miss ratio while simultaneously avoiding instability.

According to one exemplary embodiment 10 of the present invention, which is shown in FIG. 1. The headend facility 11 may either be a cable headend or a satellite uplink. If the headend facility 11 is a cable headend, it outputs multiple signals, which are then combined at the RF combiner 12. The broadcast signals are then transmitted over the HFC network 13 to multiple consumer devices, such as Motorola DCTs, 1-m 14, 15. The content of the in-band transport channels 1 through n may be generated within the headend facility 11 or an uplink facility whose signals are received in the head end and transcoded for cable distribution. All in-band channels are then combined for transmission on the HFC network cable and the signals are received and processed by the consumer devices 1 through m 14, 15. The transport protocol may conform to MPEG-2 or DOCSIS. In either case, the download mechanism described is abstracted from the details of the underlying transport protocol and the associated lower layers. An example of the in-band channels comprises a relatively low data rate channel encoded in the MPEG-2 data stream. For example, 64, 256 or 512 Kbps of the approximately 30 Mbps in a given MPEG-2 channel is allocated to data download.

Current download implementations utilize the out-of-band channel (not shown), which is a QPSK carrier allocated on a selected frequency residing between 70 and 130 MHz, and has a total data rate of about 2 Mbps, which has limited capacity, not to mention that these files grow in size, the download time becomes undesirably long. Alternatively, even if the file is placed on a single in-band channel, the consumer device can only download at much lower rate, as determined by the processor type and the efficiency of the firmware. So a higher speed channel does not necessarily provide a complete solution. Since memory and storage capabilities continue to increase in these devices, a download scheme that can take advantage of these capabilities is desired. This scheme is described below.

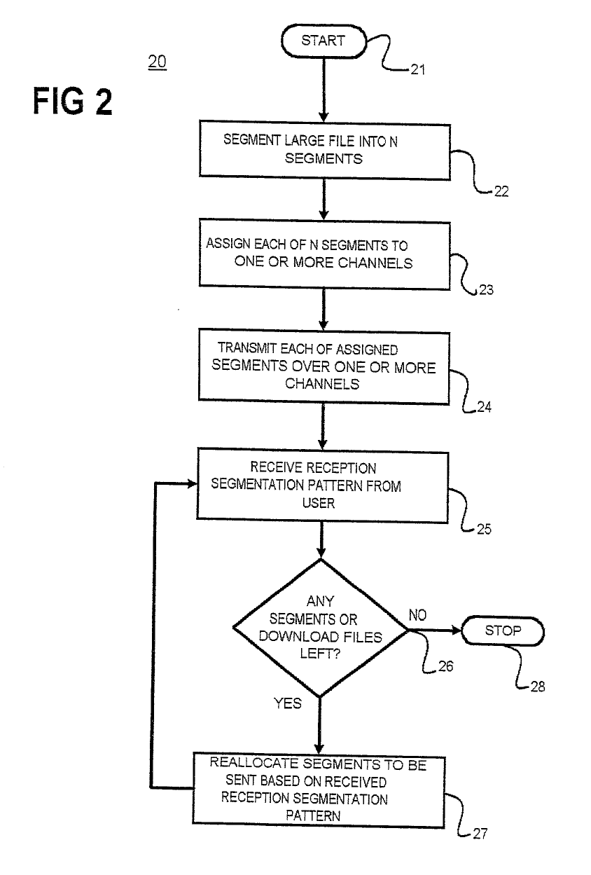

Turning to FIG. 2, shown therein is an exemplary embodiment 20 of a method for performing downloading according to one aspect of the present invention. It should be noted that the designated head end or uplink controller/download server overseeing the download mechanism carries out the following download steps, except those set forth at the receiver end.

After initializing 21, the download server segments the download file into N segments 22. Each file segment (1 of N) is designed to fit in one of the potential channels, e.g., each segment has a total block length that is suitable to be downloaded in one of the potential channels in a predetermined short length of time, such as one minute based on the data rate of a potential channel. In some embodiments herein the file segments are not necessarily identical, in that, some file segments are designed to fit in larger bandwidth channels, whereas other file segments are designed to fit in smaller bandwidth channels. In these embodiments the file is segmented into file segment classes, and then segmented within each class to account for the type of channel to which the file segment class is assigned.

Next, the N segments are then carouseled on N channels. In other words, each of the N segments is assigned a particular channel (step 23) and forwarded to the user(s) over the assigned channel independently of the other N-1 segments (step 24). At the receiving end, these segments are then recombined in their original order by the processor/receiver at the receiving end based on a format header or like information that provides some indication of the relative order of a given block or segment.

Optionally, the segmenting algorithm may optimize the download time based on: file size, unused bandwidth (bit rate available) per multiplex, the number of available multiplexes (channels), or channels most viewed during the download period (to maximize the hit/miss ratio). For example, a relatively smaller file can be split into fewer constituent elements, whereas a larger file may require more elements. In this case, the smaller file can be transmitted over a few more likely viewed channels, whereas the larger file may require employing less likely to be viewed channels.

Another example of the optimization program can split the file among both in-band and out-of-band channels, thereby employing both types of channels to achieve the download in the most efficient manner.

Still another example of the optimization program can begin the download process employing all available channels. Subsequently, based on acknowledgements regarding successfully received elements, the optimization program can then reallocate the unsent elements among the channels on which the program received successful acknowledgements.

Next, when the receiver (e.g., a Motorola DCT) is tuned to a given channel that has associated with it one or more segments to be downloaded, the receiver (e.g., a Motorola DCT) starts downloading these segments as a background process (i.e., without disrupting the viewer). To prevent errors in the download process, the download task may remain active until all segments have been downloaded, even if the viewer changes channels.

Moreover, the file segmentation download pattern can be captured (e.g., which segments have been received on which channel) at the receiving end (such as the Motorola DCT) and forwarded to the headend controller/download server for fine-tuning future segment/channel allocation downloads (see step 25). For example, if the average number of received segments per channel is n, and there are three channels with a number of segments far exceeding n, then the additional channel segments may be allocated to these particular channels that have successfully facilitated delivery or successful receipt of m segments. Potentially, segments assigned to other channels that have not been downloaded may be reassigned to one of the channels that successfully downloaded one or more segments. This provides a feedback loop in the downloading process, thereby providing rapid reconfiguration of the downloading assignments, as necessary to optimize performance on a per download basis.

Additionally, in some cases, the adaptive allocation scheme may be applied during a given download, in which case the server checks to determine if additional segments or download files remain to be transmitted (step 26). If not, the process ends 27. If there are remaining segments or download files to be transmitted, these segments may be reallocated among the various channels based on the received segmentation pattern, e.g., indications as to which channels were successfully downloaded. Steps 26-28 are then repeated until the file is successfully transmitted.

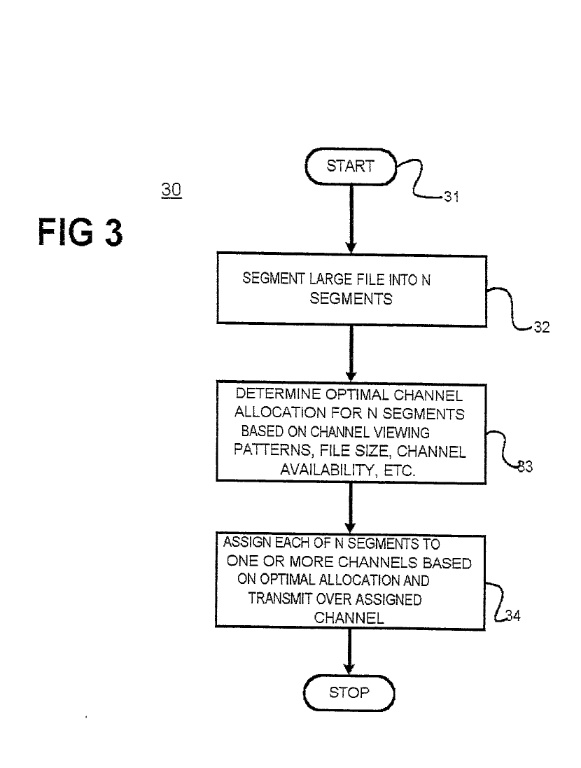

FIG. 3 shows a second exemplary embodiment 30 of a method for downloading a large file over a multiple data service communications network according to another aspect of the present invention. Once the process starts 31, as before, the file is first segmented into multiple (N) segments 32. An optimal allocation of the file segments among the available channels is then determined 33. This optimal allocation is based on the available channels, viewing patterns among the user or users to which the file is to be transmitted, file size, and other factors. For example, one can select the channels most likely viewed by one or more target users during the selected download period and then allocate the file segments to in-band channels associated with these likely to be viewed channels (step 34). Once a viewer tunes to a channel having a file segment associated with it, the downloading process will continue despite the channel being changed away from this channel. This ensures the download process will complete. Of course, if file segments remain to be downloaded due to the channel not being tuned to by the user, the file segments may be reallocated amongst the other channels in an interactive manner.

The system operator may designate part of a channel for background download such that any consumer devices that have not received all of the segments can be instructed to tune to this particular channel to complete the download. A re-tuning of this nature is only permissible if currently the consumer device is in stand-by mode (e.g., not being used to view any programming).

Although various embodiments are specifically illustrated and described herein, it will be appreciated that modifications and variations of the invention are covered by the above teachings and are within the purview of the appended claims without departing from the spirit and intended scope of the invention. While the above has been described with respect to cable television and a Digital Cable Terminal, the embodiments and the inventions herein apply to a consumer satellite receiving device, digital television receiver or the like. Furthermore, these examples should not be interpreted to limit the modifications and variations of the invention covered by the claims but are merely illustrative of possible variations.

What is claimed is:

1. A method for transferring a file over a network comprising:
segmenting the particular file into a plurality of file segments, each of which file segments has a predetermined block length;
selecting a plurality of channels over which to transmit the plurality of file segments; and
transmitting the plurality of file segments over the plurality of channels.

2. The method according to claim 1, wherein the network comprises a cable network broadcasting a plurality of broadband in-band channels, and at least one out-of-band channel.

3. The method according to claim 2, further comprising receiving a request for the particular file at a cable headend via a return channel from the user.

4. The method according to claim 2, further comprising receiving a request for the particular file from the user at a satellite uplink station.

5. The method according to claim 1, further comprising constructing the particular file from the plurality of file segments received by a receiving device.

6. The method according to claim 1, further comprising segmenting the particular file based on a distribution function of viewed channels by the users relative to a time of download.

7. The method according to claim 1, further comprising initially utilizing a unified distribution scheme, in which a plurality of segments are spread out evenly across a given number of predetermined channels, during the download and subsequently optimizing the download distribution pattern based on a reception pattern by a resident program operating in conjunction with the download function.

8. The method according to claim 1, further comprising periodically tracking segment reception patterns in the receiving end and sending this information upon request to a downloading device.

9. The method according to claim 8, further comprising analyzing by the downloading device a segment reception pattern to adjust a segment-in-band channel download allocation to optimize reception of all file segments by the receiving devices.

10. A method for transmitting a file to a user over a broadband communications network including a plurality of channels being transmitted to the user and at least one return channel from the user comprising:
segmenting the file into a plurality of N segments;
carouselling the plurality of N segments on a plurality of N channels; and optimizing the download time based on file size, unused bandwidth per multiplex, and a number of available multiplexes or channels most viewed during a download period.

11. The method according to claim 10, further comprising upon the user tuning to a channel that has one or more segments associated with it, downloading the one or more segments as a background process, which download process remains active until all said one or more segments have been downloaded even if the viewer changes channels.

12. The method according to claim 11, further comprising capturing a segmentation download pattern, which defines which segments have been downloaded on which channel.

13. The method according to claim 11, further comprising sending back a segmentation download pattern for fine tuning future segment/channel allocation downloads.

14. A method for transferring a file to one or more users over a communications link that includes at least a plurality of channels each of which is embedded in a broadcast channel, comprising:
creating a plurality of file segments from the file;
transmitting the plurality of file segments over the plurality of channels independently of each other; and reconstructing the file from the plurality of file segments received by a receiving device.

15. The method according to claim 14, further comprising optimizing a selection of the plurality of channels over which the plurality of file segments is transmitted based on a viewing pattern of the one or more users.

16. The method according to claim 14, further comprising determining a reception pattern of the file segments at each of the one or more users and forwarding the reception pattern to a server controlling the transmission of the file segments.

17. The method according to claim 16, further comprising reallocating any unsent file segments among the plurality of channels based on the received reception pattern at the one or more users.

18. The method according to claim 16, further comprising continuing to reallocate any unsent files based on received reception patterns from the one or more users.

19. The method according to claim 16, further comprising initially utilizing a unified distribution scheme, in which the plurality of file segments are spread out evenly across a given number of channels during the download.

20. The method according to claim 19, further comprising subsequently optimizing a download distribution pattern based on a reflected pattern by a resident program operating in conjunction with the download function at each of the one or more users.

21. An apparatus for transferring a file over a network comprising:
a processor segmenting the particular file into a plurality of file segments, each of which file segments has a predetermined block length, said processor selecting a plurality of channels over which to transmit the plurality of file segments; and
a transmitter transmitting the plurality of file segments over the plurality of channels.

22. The apparatus according to claim 21, further comprising a receiver receiving a plurality of file segments and constructing the particular file from the plurality of file segments received.

23. The apparatus according to claim 21, wherein the processor segments the particular file based on a distribution function of viewed channels by the users relative to a time of download.

24. The apparatus according to claim 21, wherein the processor initially utilizes a unified distribution scheme, in which a plurality of segments are spread out evenly across a given number of predetermined channels, during the download and subsequently optimizes the download distribution pattern based on a reception pattern by a resident program operating in conjunction with the download function.

25. The apparatus according to claim 21, wherein the receiver further comprises a processor periodically tracking segment reception patterns and sending this information upon request to the processor that selects the channels for transmission.

26. The apparatus according to claim 25, wherein the processor on the transmitting side analyzes a segment reception pattern to adjust a segment-in-band channel download allocation to optimize reception of all file segments by the receiver.

27. An apparatus for transmitting a file to a user over a broadband communications network including a plurality of channels being transmitted to the user and at least one return channel from the user, said apparatus comprising:
a processor segmenting the file into a plurality of N segments; and
a transmitter carouselling the plurality of N segments on a plurality of N channels, wherein said processor optimizes a download time based on file size, unused bandwidth per multiplex, and a number of available multiplexes or channels most viewed during a download period.

28. The apparatus according to claim 27, further comprising a receiver, wherein upon the user tuning to a channel that has one or more segments associated with it, downloads the one or more segments as a background process, which download process remains active until all said one or more segments have been downloaded even if the viewer changes channels.

29. The apparatus according to claim 28, wherein the receiver captures a segmentation download pattern, which defines which segments have been downloaded on which channel.

30. The apparatus according to claim 29, wherein the receiver sends back a segmentation download pattern for fine tuning future segment/channel allocation downloads.

31. An apparatus for interacting with a first processor transmitting a file to a user over a broadband communications network including a plurality of channels being transmitted to the user and at least one return channel from the user, said apparatus comprising:
a receiver receiving a plurality of file segments on the plurality of channels and constructing the file from the received file segments;
a second processor tracking the received file segments to determine a reception pattern and a channel on which each file segment was received; and
a transmitter coupled to the processor and forwarding the reception pattern to the first processor over the at least one return channel.

32. The apparatus according to claim 31, wherein the receiver and the second processor include one or more of the following: a digital cable terminal, a satellite receiver, a digital television receiver and a cable modem.

33. A method for interacting with a first processor transmitting a file to a user over a broadband communications network including a plurality of channels being transmitted to the user and at least one return channel from the user, said method comprising:
receiving a plurality of file segments on the plurality of channels;
constructing the file from the received file segments;
tracking the received file segments to determine a reception pattern and a channel on which each file segment was received; and
forwarding the reception pattern to the first processor.
